(19) United States
(12) Patent Application Publication
(10) Pub. No.: US 2026/0230443 A1
(43) Pub. Date: Aug. 6, 2026

(54) LOCATION, CONSENT, AND REASSIGNED IDENTIFIER MANAGEMENT FOR A COMMUNICATION SERVICES PLATFORM

(71) Applicant: Twilio Inc., San Francisco, CA (US)

(72) Inventors: Anurag Tiwari, Kanpur (IN); Benjamin Adam Croes, Oakland, CA (US); Samarpan Das, Bangalore (IN); Sayantan Das, Bengaluru (IN); Raushan Jha, Bengaluru (IN); Anup Kawtia, Bengaluru (IN); Prabha Kumari, Gaya (IN)

(21) Appl. No.: 19/044,315

(22) Filed: Feb. 3, 2025

(51) Int. Cl. H04L 51/212; H04L 51/222; H04L 51/224

(52) U.S. Cl. CPC H04L 51/212; H04L 51/224; H04L 51/222

(57) ABSTRACT

A method for location, consent, and reassigned identifier management for a communication services platform includes receiving, from a customer of the platform, a first messaging request to transmit a first message. The platform determines whether a first communication endpoint identifier of the request is associated with an opt-out indicator. If not, the method includes determining whether a message category associated with the first message is subject to a time-of-day restriction. If the message category is subject to the time-of-day restriction, the method includes determining whether a current time of day complies with the time-of-day restriction. If the current time of day complies with the time-of-day restriction, the method includes causing the first message to be transmitted to the communication endpoint.

### TECHNICAL FIELD

Aspects and implementations of the disclosure relate to computer software, and more specifically, to systems and methods for location, consent, and reassigned identifier management for a communication services platform.

### BACKGROUND

Entities can use communication services platforms to manage their communications, for example, via text messages. A communication services platform may classify text messages sent by entities. The classification may assist the communication services platform in determining a use case of the message and determining whether the message complies with the platform's acceptable use policy or applicable laws and regulations.

### BRIEF DESCRIPTION OF THE DRAWINGS

Aspects and implementations of the disclosure will be understood more fully from the detailed description given below and from the accompanying drawings of various aspects and implementations of the disclosure, which, however, should not be taken to limit the disclosure to the specific aspects or implementations, but are for explanation and understanding.

FIG. 1 illustrates an example system architecture for location, consent, and reassigned identifier management for a communication services platform, in accordance with some implementations of the disclosure.

FIG. 2 illustrates an example flow of data for location, consent, and reassigned identifier management for a communication services platform, in accordance with some implementations of the disclosure.

FIG. 3 depicts a flow diagram of an example method for location, consent, and reassigned identifier management for a communication services platform, in accordance with some implementations of the disclosure.

FIG. 4 is a block diagram illustrating an exemplary computer system, in accordance with some implementations of the disclosure.

### DETAILED DESCRIPTION

A communication services platform, such as a Software as a Service (SaaS) platform, can offer various communication services to users. For example, a SaaS platform can offer messaging service tools that facilitate messaging conversations, e.g., the sending and/or receiving of messages, such as short message service (SMS) messages, multimedia messaging service (MMS) messages, and/or instant messaging (IM) messages, to and from devices via various communication channels. The communication services platform can offer voice call service tools that facilitate voice conversations, e.g., the making and receiving of voice calls using various protocols, such as Voice over Internet Protocol (VoIP), various mobile communications protocols, or Session Initiation Protocol (SIP).

In some jurisdictions, applicable law may prevent sending messages related to certain categories during a certain time range (e.g., sending marketing messages between 8 p.m. and 8 a.m. local time). In order to prevent possible violations of such laws or regulations, or in order to enforce the communication services platform's acceptable use policy or other types of policies, the platform may classify the messages being forwarded and use the message classifications for determining whether a particular message may be forwarded to the destination at the current time of day. For example, in some implementations, message classification may be performed by trainable classifiers. However, determining whether a message can be forwarded at the current time of day is difficult. Without certain types of data-such as consent data related to the destination communication endpoint device, the message category of the message being forwarded, and/or location data for the destination communication endpoint device-determining whether the message can be forwarded cannot be performed accurately or efficiently.

Aspects of the disclosure address the above-mentioned and other challenges by implementing systems and methods for a communication services platform that determines whether forwarding a message from a customer to a user complies with applicable laws and regulations and/or an acceptable use policy of the platform. The platform uses consent data, a message category associated with the message (e.g., as determined by a trained artificial intelligence (AI) model), and location data to determine the compliance of sending the message. Non-compliant messages may be discarded or may be rescheduled for sending during the next compliant time window. For example, the platform may maintain a consent record storage that stores records indicating whether an end user has opted-out of receiving communications from particular customers. The platform may update the consent records in response to receiving data indicating that certain communication endpoint identifiers have been reassigned to new end users.

After determining that the recipient end user of the message has not opted-out of receiving messages from the customer, the communication services platform can employ an AI model that classifies a message into a message category based on the payload of the message. Message categories can include verification messages, marketing messages, announcement messages, or security/emergency messages. Messages classified into a certain message category may be subject to a time-of-day restriction. If the message category is subject to a time-of-day restriction (e.g., a restriction on sending messages between certain times of the day), the platform may determine a current time associated with the recipient end user. The platform can determine the current time associated with the end user using location data stored by a location record storage of the platform. The location record storage may store location records indicating a location associated with a communication endpoint identifier. The platform may update location records based on data received from customers or other sources. The platform may cause the message to be sent if sending the message at the current time complies with the time-of-day restriction. If sending the message would not comply with the time-of-day restriction, the platform may delay sending the message.

As an example, the platform may receive a message forwarding request from a customer. The platform may determine, using consent data from a consent data storage, that the recipient user of the message has not opted-out of communications from the customer. The platform can use an AI model to determine that the message is a verification message containing a one-time password (OTP) that the recipient end user can use to log into a customer's website. The platform may determine that verification messages are not subject to time-of-day restrictions and may forward the message to the recipient user. In another example, the AI model may determine that the message is a marketing message notifying the recipient user of a sale. The platform may determine that (1) marketing messages are subject to a time-of-day restriction, (2) that the local time for the recipient user is 3 a.m., and (3) applicable law restricts sending marking messages between 8 p.m. and 8 a.m. Thus, the platform may delay forwarding the marketing message until after 8 a.m. It should be noted that the communication services platform forwarding the message of the message request is sometimes referred to herein as the platform sending the message or the platform transmitting the message.

As noted above, a technical problem addressed by implementations of the disclosure is efficient, accurate, and automated real-time detection of non-compliant messages that customers provide to the communication services platform for forwarding to respective end users. The technical solution to the above-identified technical problem utilizes consent records associated with the respective destination communication endpoint identifiers of the messages, AI-determined message categories for the respective messages, and location data associated with the respective destination communication endpoint identifiers of the messages to determine whether forwarding the respective messages complies with applicable laws and regulations and/or a platform's acceptable use policy. Thus, a technical effect may include improving the accuracy of determining whether forwarding customer-provided messages is compliant with applicable laws and regulations or an acceptable use policy or whether the forwarding of the messages should be rescheduled or prevented.

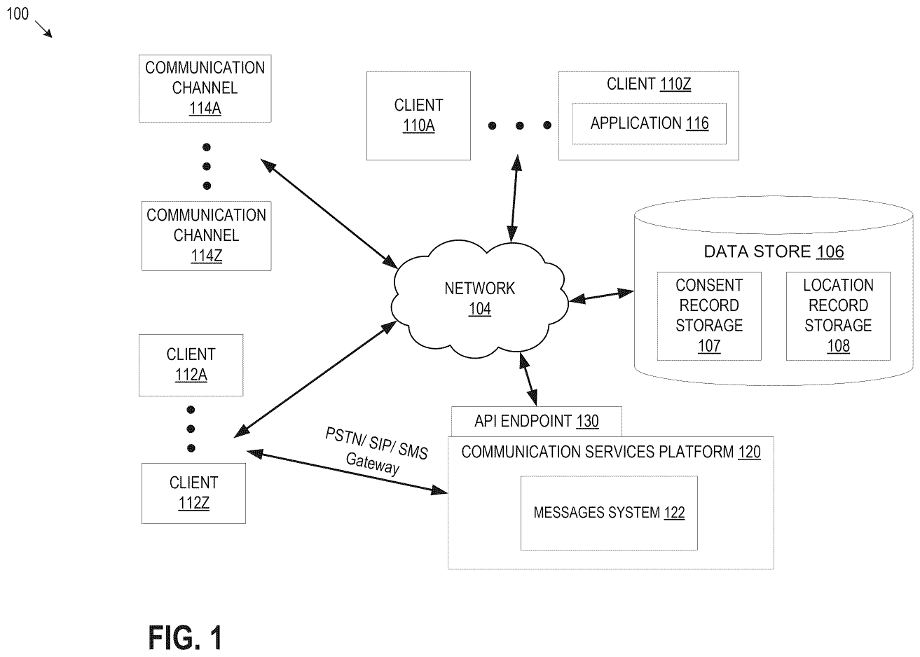

FIG. 1 illustrates an example system architecture 100 for location, consent, and reassigned identifier management for a communication services platform, in accordance with some implementations of the disclosure. The system architecture 100 (also referred to as a “system” herein) includes a network 104, a data store 106, one or more client devices 110A-110Z, one or more client devices 112A-112Z, one or more communication channels 114A-114Z, and a communication services platform 120 (also referred to as the “platform 120” herein). The client devices 110A-Z, the client devices 112A-112Z, and/or the communication channels 114A-114Z may be communicatively coupled to the platform 120 via the network 104. The data store 106 may be communicatively coupled to the platform 120 via the network.

In some implementations, the network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, the data store 106 is a persistent storage that is capable of storing data as well as data structures to tag, organize, and index the data. The data store 106 may be hosted by one or more storage devices, such as main memory, magnetic or optical storage-based disks, tapes or hard drives, network-attached storage (NAS), storage area network (SAN), and so forth. In some implementations, the data store 106 may be a network-attached file server, while in other implementations, the data store 106 may be some other type of persistent storage such as an object-oriented database, a relational database, and so forth, that may be hosted by the communication services platform 120 or one or more different machines coupled to the communication services platform 120 via the network 104.

In one implementation, the data store 106 may include a consent record storage 107. The consent record storage 107 may store a consent record database. The consent record database may store one or more consent records. A consent record may include data indicating whether an end user has provided consent for a customer to send messages to the end user. The consent record may include data indicating the communication endpoint identifier associated with the end user, a customer of the communication services platform 120, a consent indicator (e.g., a Boolean where TRUE indicates consent and FALSE indicates no consent), a date the consent record was created, a date the consent record was last modified, and/or other data.

In one implementation, the data store 106 may include a location record storage 108. The location record storage 108 may store a location record database, the location record database may store one or more location records. A location record may include data indicating the geographic location of an end user. The location record may include data indicating the communication endpoint identifier associated with the end user, a current location of the end user, a date the location record was created, a date the location record was last modified, and/or other data. The data indicating the current location of the end user may include a postal code; the name of a city, state/province; or other data indicating a geographic location of the end user.

In some implementations, the consent record database of the consent record storage 107 may be implemented as a relational database, object database, or other type of database. The consent record database may be implemented as a file system. The consent record database may be implemented as another type of data storage. Similarly, the location record database may be implemented as a database, file system, or other type of data storage.

The client devices 110A-Z (generally referred to as “client device(s) 110” herein) may each include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some implementations, a client device 110 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some implementations, the client devices 110A-Z may also be referred to as “user devices.”

In some implementations, a client device 110, such as the client device 110Z, can implement or include one or more applications, such as the application 116 (also referred to as “client application 116” herein) executed at the client device 110Z. In some implementations, the application 116 can be used to communicate (e.g., send and receive information) with communication services platform 120. In some implementations, application 116 can implement user interfaces (e.g., graphical user interfaces (GUIs)) that may be webpages rendered by a web browser and displayed on the client device 110Z in a web browser window. In another implementation, the user interfaces of the application 116 may be included in a stand-alone application downloaded to the client device 110Z and natively running on the client device 110Z (also referred to as a “native application” or “native client application” herein).

In some implementations, one or more client devices 110 can communicate with the communication services platform 120 using function calls, such as application programming interface (API) function calls (also referred to as “API calls” herein). For example, the one or more function calls can be identified in a request using one or more application layer protocols, such a HyperText Transfer Protocol (HTTP) (or HTTP secure (HTTPS)), and that are sent to the communication services platform 120 from the client device 110Z implementing the application 116. In some implementations, the communication services platform 120 can respond to the requests from the client device 110Z by using one or more API responses using an application layer protocol. Similarly, communication services platform 120 can communicate with one or more communication channels 114A-114Z using API function calls.

In some implementations, a communication channel 114 can be implemented by software and/or hardware through which voice calls or messages can be sent to recipient devices (e.g., organizations different from communication services platform 120). In some implementations, the communication services offered by communication channels 114A-114Z can be integrated into the communication services platform 120. In some implementations, the communication services offered by the communication channels 114A-114Z can include voice communication services, messaging services, or other types of communication services. In some implementations, messaging services can include one or more of a SMS implemented by an SMS channel, a MMS offered by an MMS channel, or an IM service (e.g., chat messaging) offered by an IM service channel. In some implementations, communication channels 114A-114Z can also include a voice channel. For example, the voice channel may implement an application to send or receive voice calls. In another example, the voice channel may be implemented by a telecommunication service provider, such as PSTN provider, mobile communication services provider, and/or VoIP services provider.

In some implementations, one or more of client devices 110 can be identified by a uniform resource identifier (URI), such as a uniform resource locator (URL). For example, the communication services platform 120 can send an API call to the client device 110Z addressed to a URL specific to the client device 110Z. In some implementations, the communication services platform 120 can be identified by a URI. For instance, the API call sent by a client device 110 to the communication services platform 120 can be directed to the URL of the communication services platform 120.

In some implementations, a communication endpoint may be a client device of the client devices 112A-Z (generally referred to as “client device(s) 112” herein). The client devices 112 may be similar to client devices 110. A client device 112 may include a device that a user can utilize to communicate with another communication endpoint. A communication endpoint may include a telephony device. A telephony device can include a Public Switched Telephone Network (PSTN)-connected device, such as a cellular phone or messaging-enabled satellite phone. In some implementations, a telephony device can also include an internet addressable voice device (e.g., non-PSTN telephony device), such as messaging-enabled VoIP phones or SIP devices, for example. In some implementations, a telephony device can include one or more messaging devices, such as a SMS network device that, for example, uses a cellular service to exchange SMS messages or MMS messages. A communication endpoint may include other types of devices, such as a landline phone. A communication endpoint can be identified by an identifier (e.g., a phone number, a network address, a universal resource identifier (URL), a numeric identifier, or an alphanumeric string).

In some implementations, the communication services platform 120 may provide communication services that include messaging services (e.g., SMS services or MMS services), voice services, email services, video services, chat messaging services (e.g., internet-based chat messaging services), or a combination thereof. Communication operations using the communication services can use one or more of a communication network (e.g., Internet), telecommunications network (e.g., such as a cellular network, satellite communication network, or landline communication network), or a combination thereof, to transfer communication data between parties.

The communication services platform 120 can include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that may be used to provide a user with access to data or services. Such computing devices may be positioned in a single location or may be distributed among many different geographical locations. For example, the communication services platform 120 may include a plurality of computing devices that together may comprise a hosted computing resource, a grid computing resource or any other distributed computing arrangement. In some implementations, the communication services platform 120 may correspond to an elastic computing resource where the allotted capacity of processing, network, storage, or other computing-related resources may vary over time.

In an illustrative example, communication services platform 120 can include a Software as a Service (SaaS) platform that can at least in part provide one or more services, such as communication services, to one or more clients. The SaaS platform may deploy services, such as software applications, to one or more clients for use as an on-demand service. For example, the SaaS platform may deliver and/or license software applications on a subscription basis while also hosting, at least in part, the software application. The licensed software applications can, at least in part, be hosted on the infrastructure, such as the cloud computing resources of the SaaS platform.

In one implementation, an organization can be a customer of the platform 120. An example of an organization may be an entity, such as a legal entity. In some implementations, an organization can be associated with an account (e.g., organizational account) of the communication services platform 120. Within the particular account of the organization, one or more sub-accounts of the communication services platform 120 may be associated with different users of the organization. In some implementations, the accounts are organized in a hierarchical structure where the organizational account is the root at the top of the hierarchy and the user accounts are nested under the organizational account. The communication services platform 120 may include an account management system that manages accounts of the communication services platform 120. Managing accounts may include functionality related to account creation, account deactivation, account suspension, account modification, or other functionality.

In some implementations, the communication services platform 120 can provision identifiers of communication endpoints to an organization's account. Such identifiers may include telephone numbers (e.g., 10-digit long code or short code). The assignment of identifiers can be flexible such that the assignment of an identifier can be one-to-one (e.g., one identifier to one user account) or one to many (e.g., one identifier to many user accounts). Where an account is provided multiple identifiers, the user of the account may be able to dynamically select which identifier to use, for example, as the sender identifier when the platform 120 forwards a message to a recipient end user.

In some implementations, the communication services platform 120 further includes a messaging system 122. The messaging system 122 may include hardware and/or software that functions to interface with one or more communication networks and/or services for facilitating SMS, MMS, IM, and/or other carrier-based messages. The messaging system 122 may receive a message forwarding request from a customer of the platform 120. The messaging system 122 may receive the message forwarding request from a client device 110 used by a customer. The messaging system 122 may cause the platform 120 to forward one or more messages based on the message forwarding request. A message forwarding request can include a data object characterizing the properties of a message. In some implementations, the messaging system 122 is associated with message forwarding requests that are programmatically initiated (e.g., an application-to-person (A2P) message).

In some implementations, a message forwarding request can include an origin endpoint. The origin endpoint may include a communication endpoint identifier included in the message forwarding request or may be specified indirectly such as through a system or account configuration or identifier (e.g., messaging conversation identifier). For example, a message may be automatically assigned an origin endpoint that is associated with an account of the customer that provided the message forwarding request, as indicated by an account configuration of the customer's account. A message forwarding request may include one or more destination endpoints, which may include one or more communication endpoint identifiers associated with the recipient end user(s) of the message. In some implementations, the message forwarding request can include a message payload, which can include any suitable type of media content including, text, audio, image data, video data, multimedia, interactive media, data, and/or any suitable type of content that can be included in a message payload.

In some implementations, the messaging system 122 may determine whether forwarding a message, as requested by a message forwarding request, complies with an acceptable use policy of the communication services platform 120 or with applicable laws or regulations. For example, applicable law may prevent sending messages related to certain message categories during a certain time range (e.g., sending marketing messages between 8 p.m. and 8 a.m.). If the messaging system 122 determines that sending the message would comply with the acceptable use policy and/or applicable laws and regulations, the messaging system 122 may cause the message to be sent using the platform 120. However, if sending the message would not comply with the acceptable use policy and/or applicable laws and regulations, the messaging system 122 may prevent transmission of the message or may delay the transmission of the message.

In some implementations, the messaging system 122 may determine, using the consent record storage 107, whether a communication endpoint identifier associated with a message is associated with an opt-out indicator. If the messaging system 122 determines that the communication endpoint identifier is associated with an opt-out indicator, the messaging system 122 may prevent or delay the transmission of the message to the recipient communication endpoint. Because of the large number of communication endpoint identifiers that could be used as recipient endpoint identifiers in messages to be forwarded by the messaging system 122, storing consent records indicating that end users have opted-in to communications from certain customers may be resource-intensive for the consent record storage 107 or may even be infeasible. Thus, in some implementations, the consent record storage 107 may primarily store consent records indicating that end users have opted out of communications from certain customers.

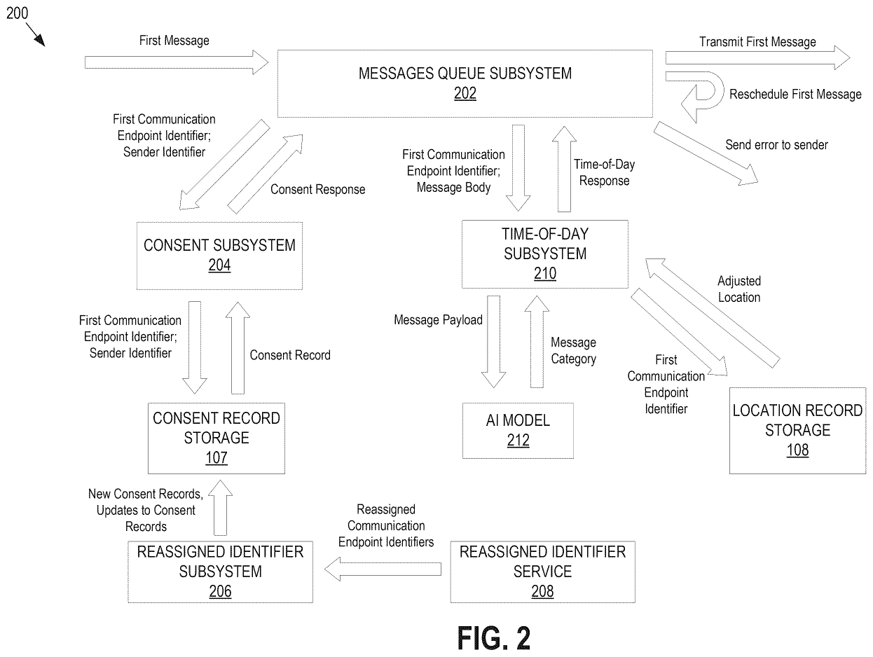

In one implementation, the messaging system 122 may determine whether a recipient communication endpoint identifier has been reassigned to a new end user. The messaging system 122 may determine whether to update one or more consent records stored in the consent records storage 107 in response to the identifier reassignment. In some implementations, if a communication endpoint identifier is reassigned, consent records associated with the reassigned identifier may become outdated, and the consent record storage 107 may temporarily store a consent record indicating that an end user associated with the reassigned identifier has opted-in to communications from certain customers. Further details regarding the opt-outs and/or opt-ins stored by a consent record, and functionality regarding tracking consents related reassigned communication endpoint identifiers are provided below in relation to FIG. 2.

In some implementations, the messaging system 122 may determine, using a message category of the message and/or a current time of day associated with the recipient communication endpoint identifier of the message, whether sending the message complies with a time-of-day restriction. If the messaging system 122 determines that sending the message complies with the time-of-day restriction, the messaging system 122 may forward the message. If sending the message would not complying with the time-of-day restriction, the messaging system 122 may prevent or reschedule the transmission of the message to the recipient communication endpoint.

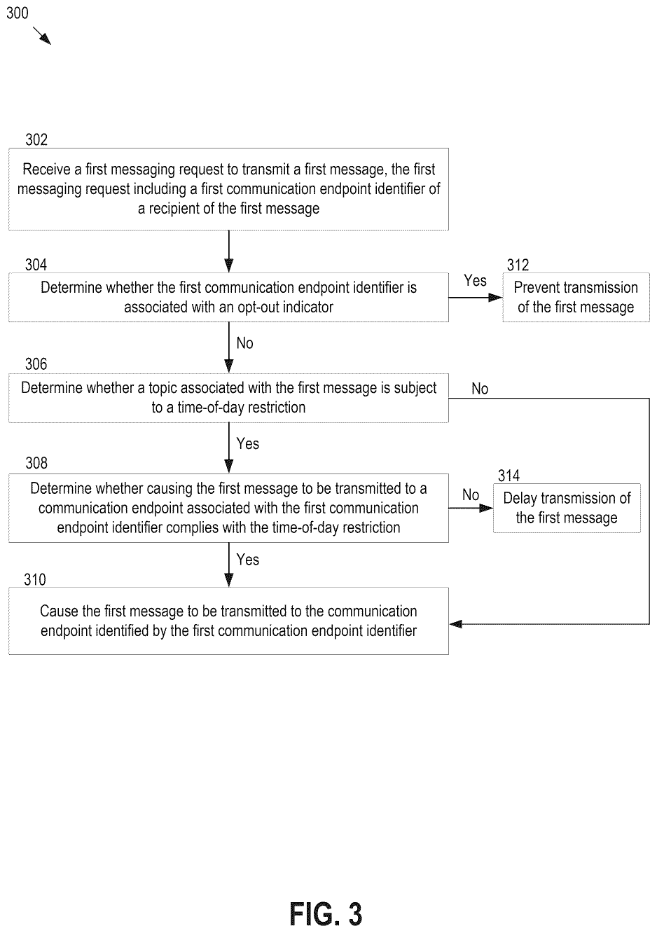

In one implementation, the messaging system 122 may use an AI model to determine the message category of the message. The AI model may determine the message category of the message based on the message payload (e.g., the content of the body of the message). The messaging system 122 may use the location record storage 108 to determine a location associated with the recipient communication endpoint identifier and to determine a current time associated with the location. Further details regarding the messaging system 122 are provided below in relation to FIG. 2 and FIG. 3.

In some implementations, the communication services platform 120 provides one or more API endpoints 130 that can expose services, functionality or content of the communication services platform 120 to one or more of client devices 110 or communication channels 114A-114Z. In some implementations, an API endpoint 130 can be an endpoint of a communication channel in which the other endpoint can be implemented by another system, such as the client device 110Z or communication channel 114Z. In some implementations, the API endpoint 130 can include or be accessed using a resource locator, such a universal resource locator (URL), of a server or service. The API endpoint 130 can receive requests from other systems, and in some cases, return a response with information responsive to the request. In some implementations, HTTP or HTTPS methods can be used to communicate to and from API endpoint 130.

In some implementations, the API endpoint 130 can function as a computer interface through which communication requests, such as message and/or voice requests, are received and/or created. The communication services platform 120 may include one or more types of API endpoints.

In some implementations, the API endpoint 130 can include a messaging API. External entities or systems can use the messaging API to send, to the communication services platform 120, a communication to create message content and/or request sending of a message. The messaging API may be used in programmatically creating message content and/or requesting sending of one or more messages. In some implementations, the messaging API is implemented in connection with a multitenant communication service wherein different accounts (e.g., authenticated entities) can submit independent requests. These requests made through the messaging API can be managed with consideration of other requests made within an account and/or across multiple accounts on the communication service.

In some implementations, the messaging API may be used in initiating general messaging or communication requests. For example, a messaging request may indicate one or more destination endpoints (e.g., as identified by recipient phone numbers), message content (e.g., text and/or media content), and possibly an origin endpoint (e.g., as identified by a phone number to use as the “sending” phone number).

In some implementations, the messaging API may be any suitable type of API such as a Representational State Transfer (REST) API, a GraphQL API, a Simple Object Access Protocol (SOAP) API, and/or any suitable type of API. In some implementations, the communication services platform 120 can expose through the API, a set of API resources which when addressed may be used for requesting different actions, inspecting state or data, and/or otherwise interacting with the communication platform.

In some implementations, a REST API and/or another type of API may work according to an application layer request and response model. An application layer request and response model may use HTTP, Hypertext Transfer Protocol Secure (HTTPS), SPDY, or any suitable application layer protocol. Herein, HTTP-based protocol is described for purposes of illustration, the application layer may use other protocols. HTTP requests (or any suitable request communication) to the communication services platform 120 may observe the principles of a RESTful design or the protocol of the type of API. RESTful is understood in this document to describe a Representational State Transfer architecture. The RESTful HTTP requests may be stateless, thus each message communicated contains all necessary information for processing the request and generating a response. The API service can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

In some implementations, the API endpoint 130 can include a console, administrator interface, or other suitable type of user interface. Such a user-facing interface can be a graphical user interface. Such a user interface may additionally work in connection with a programmatic interface.

In some implementations, one or more APIs that the application 116 executing on a desktop client device (e.g., a desktop application) uses to access the messaging system 122 can be different APIs than the APIs used by the application 116 executed on a mobile client device (e.g., mobile application) to access the messaging system 122. In one implementation, the APIs used to communicate between the messaging system 122 and other systems of the communication services platform 120 may be private APIs that are not accessible by client devices 110 (or client devices 112).

Although implementations of the disclosure are discussed in terms of communication service platforms, implementations may also be generally applied to any type of platform, system or service. Furthermore, in general, functions described in some implementations as being performed by the communication services platform 120 can also be performed on the client devices 110A-110Z in other implementations (and vice versa), if appropriate. In addition, the functionality attributed to a particular component can be performed by different or multiple components operating together. The communication services platform 120 can also be accessed as a service provided to other systems or devices through appropriate APIs.

In situations in which the systems discussed here collect personal information about users, or may make use of personal information, the users may be provided with an opportunity to control whether the communication services platform 120 collects user information, or to control whether and/or how to receive content from the communication services platform 120 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the communication services platform 120.

FIG. 2 illustrates an example flow of data 200 for location, consent, and reassigned identifier management for a communication services platform 120, in accordance with some implementations of the disclosure. Some components of FIG. 1 are used to help describe aspects of FIG. 2. For example, the data flow 200 depicts the consent record storage 107 and the location record storage 108 of FIG. 1.

In one implementation, the data flow 200 further depicts a messages queue subsystem 202. The messages queue subsystem 202 may include hardware and/or software that maintains a queue of messages to be forwarded by the messaging system 122. The messages queue subsystem 202 may receive messages to be forwarded by the messaging system 122, enqueue the messages in the messages queue, and dequeues a message from the messages queue. The messaging system 122 may transmit a dequeued message, reschedule the transmission of the message, or prevent the transmission of the message based on whether sending the message would comply with the platform's 120 acceptable use policy or applicable laws and/or regulations.

A customer of the communication services platform 120 may submit a first message forwarding request using the application 116, and the platform 120 may receive the first message forwarding request via an API endpoint 130. The first message forwarding request may include a request from a customer of the communication services platform 120 to forward (e.g., over a communication channel 114A-Z) the first message to a recipient communication endpoint identified by a recipient communication endpoint identifier. The first message forwarding request may include a sender communication endpoint identifier associated with the customer The first message forwarding request may include a message. The message may include a message payload (e.g., text data, image data, etc.). The first message forwarding request may include a message category provided by the customer (e.g., as a user input provided to the application 116). The platform 120 may provide the first message forwarding request to the messaging system 122, which may provide the message of the first message forwarding request to the messages queue subsystem 202. The messages queue subsystem 202 may enqueue the message.

In some implementations, the messages queue subsystem 202 may provide the recipient communication endpoint identifier and the sender communication endpoint identifier of the message to a consent subsystem 204. The consent subsystem 204 may include hardware and/or software that determines whether an end user associated with a communication endpoint identifier has opted-out of communications from a customer of the platform 120. In some implementations, the consent subsystem 204 may determine whether the recipient communication endpoint identifier is associated with an opt-out indicator. For example, the consent subsystem 204 may determine whether the consent record storage 107 stores a consent record associated with the recipient communication endpoint identifier. The consent subsystem 204 may perform a look up in the consent record database using the recipient communication endpoint identifier and the sender identifier. Performing the lookup may result in the consent subsystem 204 identifying a consent record indicating that the end user associated with the recipient communication endpoint identifier has opted-out of communications from the customer associated with the sender identifier. The sender identifier may be a communication endpoint identifier associated with the customer that submitted the first messaging request.

In one implementation, the consent record database of the consent record storage 107 may indicate that the end user associated with the recipient communication endpoint identifier has opted-out of communications from the sender by storing a consent record associated with the recipient communication endpoint identifier and the sender identifier. In other words, in some implementations, the consent record database may only store consent records indicating opt-outs. The consent subsystem 204 may perform a look up in the consent record database to determine if the consent record database stores a consent record associated with the recipient communication endpoint identifier and the sender identifier. The consent subsystem 204 may determine that, because the consent record exists in the consent record database, the end user associated with the recipient communication endpoint identifier has opted-out of communications from the sender. If the result of the lookup indicates that such a consent record does not exists in the consent record database, the consent subsystem 204 may determine that the end user associated with the recipient communication endpoint identifier has not opted-out of communications from the sender.

In some implementations, the consent record database of the consent record storage 107 may indicate that the end user associated with the recipient communication endpoint identifier has opted-out of or opted-into communications from the sender by storing a consent record that is associated with the recipient communication endpoint identifier and the sender identifier and that further includes data indicating an opt-in or an opt-out. The consent subsystem 204 may perform a look up in the consent record database to determine if the consent record database includes a consent record associated with the recipient communication endpoint identifier and the sender identifier. The consent subsystem 204 may determine from the data in the consent record that indicates an opt-in or an opt-out that the end user associated with the recipient communication endpoint identifier has opted-out of or opted-into communications from the sender. In some implementations, the consent record database may store consent records with data indicating an opt-in for a predetermined amount of time and then may remove the consent record from the consent record database. The predetermined amount of time may be a day, week, two weeks, a month, or some other amount of time.

A communication endpoint identifier may become disassociated with an end user or the communication endpoint of the end user, which may be referred to as the communication endpoint identifier being “reassigned.” The communication endpoint identifier being reassigned may result in a consent record associated with that communication endpoint identifier in the consent record database becoming outdated. For example, where the communication endpoint identifier is a phone number, the end user may change to a different mobile phone carrier, resulting in the end user ceasing to use the user's previous phone number and using a different phone number. In one embodiment, as seen in FIG. 2, a reassigned identifier subsystem 206 may update a consent record in the consent record database of the consent record storage 107 in response to a communication endpoint identifier being reassigned.

The reassigned identifier subsystem 206 may receive one or more reassigned communication identifiers from a reassigned identifier service 208. The reassigned identifier service 208 may include a computing platform, database, or other computing instance that provides data indicating whether a communication endpoint identifier has been reassigned. In one implementation, the reassigned identifier subsystem 206 may receive a notification from the reassigned identifier services 208 (e.g., via an API of the reassigned identifier service 208). The notification may include one or more reassigned communication endpoint identifiers, a reassignment date for each reassigned communication endpoint identifier, or other data associated with the reassignment of the communication endpoint identifier.

In one implementation, the reassigned identifier subsystem 206 may add one or more consent records to, or modify one or more consent records stored in, the consent record database of the consent record storage 107 based on the reassigned identifiers notification. In one embodiment, the reassigned identifier subsystem 206 may look up a consent record in the consent record database that is associated with a communication endpoint identifier listed in the reassigned identifiers notification. If the reassigned identifier subsystem 206 does not locate the consent record (e.g., because the consent record database does not currently store a consent record that includes the specified communication endpoint identifier), the reassigned identifier subsystem 206 may add a consent record that includes the communication endpoint identifier and the reassignment date associated with the identifier. If the reassigned identifier subsystem 206 successfully locates the consent record, the reassigned identifier subsystem 206 may remove the consent record from the consent record storage 107. If the reassigned identifier subsystem 206 successfully locates the consent record and the consent record includes (1) data indicating an opt-in and (2) an opt-in date before the reassignment date, then the reassigned identifier subsystem 206 may remove the opt-in indicator and opt-in date and may modify the consent record to include an opt-out date that matches the reassignment date.

An end user associated with a communication endpoint identifier may opt-out of communications from a customer of the communication services platform 120, for example, by sending a message to a communication endpoint identifier associated with the customer, via a message routing provider, that includes text indicating the user of the communication endpoint's intent to opt-out of communications from a customer (e.g., the message may include the word “STOP” or “unsubscribe”). The end user opting out in this manner may result in a consent record associated with end user's communication endpoint identifier in the consent record database becoming outdated. In some embodiments, the message routing provider may provide an opt-out notification associated with the end user's communication endpoint identifier to the communication services platform 120. The platform 120 may receive the opt-out notification from the message routing provider, and the platform 120 may generate and store an opt-out record associated with the end user's communication endpoint identifier in the consent record database of the consent record storage 107.

In some implementations, an end user associated with a communication endpoint identifier may opt-out of communications from a customer of the communication services platform 120, for example, by notifying the customer via the customer's website or an unsubscribe link in an email from the customer. The end user opting out in this manner may result in a consent record associated with end user's communication endpoint identifier in the consent record database becoming outdated. The customer may use the application 116 of the client device 110Z to provide opt-out data to the communication services platform 120 via a customer API of the platform 120. The opt-out data may include data indicating (1) the communication endpoint identifier associated with the end user and (2) the customer whose messages are being opted-out. The platform 120 may receive the opt-out data and generate an opt-out record associated with the end user's communication endpoint identifier in the consent record database of the consent record storage 107.

In one implementation, responsive to the consent subsystem 204 determining that the recipient communication endpoint identifier is associated with an opt-out indicator, the consent subsystem 204 may send a consent response to the messages queue subsystem 202. The consent response may include data indicating that the recipient communication endpoint identifier is associated with an opt-out. In response, the messages queue subsystem 202 may prevent the messaging system 122 from forwarding the message to the recipient communication endpoint identifier. The messages queue subsystem 202 may cause an error message to be sent to the customer that provided the first messages request. The error message may include data informing the customer that the first message could not be sent because the end user associated with the recipient communication endpoint identifier has opted-out of communications from the customer.

In some implementations, responsive to the consent subsystem 204 determining that the recipient communication endpoint identifier is not associated with an opt-out indicator, the consent subsystem 204 may send a consent response to the messages queue subsystem 202 that indicates that the recipient communication endpoint identifier is not associated with an opt-out. In response, the messages queue subsystem 202 may send the recipient communication endpoint identifier and the payload of the first message to a time-of-day subsystem 210.

The time-of-day subsystem 210 may determine whether a message category associated with the first message is subject to a time-of-day restriction. A time-of-day restriction may include a restriction on sending messages of a predetermined message category between a predetermined time range. For example, a time-of-day restriction may include a restriction on sending marketing, political, educational, religious, or charitable messages between the hours of 9 p.m. and 8 a.m. in the location where the message recipient is located. In some implementations, determining the message category associated with the first message may include the time-of-day subsystem 210 providing the payload of the first message to an AI model 212 and using the AI model 212 to generate an output based on the payload of the first message. The output may include a message category associated with the first message. The AI model 212 may provide the message category associated with the first message to the time-of-day subsystem 210.

In one implementation, the AI model 212 may include one or more of artificial neural networks (ANNs), decision trees, random forests, support vector machines (SVMs), clustering-based models, Bayesian networks, or other types of AI models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network. ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In some implementations, the AI model 212 may include a generative AI model. A generative AI model may be trained and/or configured to generate new and original content. A generative AI model can include a generative adversarial network (GAN), a variational autoencoder (VAE), or a large language model (LLM). In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks. The generative AI model can use other machine learning models including an encoder-decoder architecture including one or more self-attention mechanisms, and one or more feed-forward mechanisms. In some implementations, the generative AI model includes an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including RNNs, CNNs, or transformer networks.

In some implementations, as discussed above, a customer may provide, with the first message forwarding request, a message category. In response to the first message forwarding request including the customer-provided message category, the time-of-day subsystem 210 may compare the AI model-determined message category with the customer-provided message category. Responsive to the AI model-determined message category and the customer-provided message category not matching, the communication services platform 120 may notify the customer so the customer can make corrections to future message forwarding requests. The time-of-day subsystem 210 may use the customer-provided message category to determine whether the message category is subject to a time-of-day restriction, as discussed below, or the time-of-day subsystem 210 may use the AI model-determined message category to determine whether the message category is subject to a time-of-day restriction.

In one implementation, the time-of-day subsystem 210 may determine that the message category associated with the first message is not subject to a time-of-day restriction. The time-of-day subsystem 210 may send the messages queue subsystem 202 a time-of-day response indicating that the message category of the first message is not subject to a time-of-day restriction. In response, the messages queue subsystem 202 may cause the first message to be forwarded to a communication endpoint identified by the recipient communication endpoint identifier.

In some implementations, messages not subject to a time-of-day restriction can include verification, transactional, announcement, customer support, security, or healthcare messages. Messages subject to a time-of data restriction can include conversational, marketing, political, educational, charitable, or religious messages. In one implementation, a message category may be a verification category. A verification message may include a message associated with verifying an identity of a user associated with a customer that sent the message. Examples of verification messages include messages that include one-time passwords (OTPs), multi-factor authentication (MFA) verification codes, or other data used to verify that a user has requested an action. A message category may be a transactional category. A transactional message may include a message associated with providing transactional information to the customer that sent the message to the user. A transactional message may include a message that includes a product or service order confirmation, a delivery notification, a user account notification (e.g., a notification that the user's account has been created, changed, or suspended), or other data associated with a transaction associated with the user receiving the message.

A message category may be a marketing category. A marketing message may include a message associated with providing marketing information to the user. A marketing message may include a message notifying the user about promotions, discounts, events, offers, product or service announcements, or rewards programs. A message may be an announcements category. An announcement message may include a message associated with notifying a user about emergency alerts, traffic conditions, service disruptions, public safety campaigns, or other similar events. A message category may be a customer support category. A customer support message may include a message associated with notifying a user about customer-related issues, including updates to services or products the user has purchased, issue resolution notifications, customer service availability notifications, order confirmations, or the like.

A message category may be a security/emergency message category. A security/emergency message may include a message notifying the user about security-or emergency-related information. A security/emergency message may include a message associated with the security of an account of the user. For example, a security/emergency message may notify the user about a data breach, a password change or reset, a suspicious transaction, scams, or other security-related information. A security/emergency message may include a message notifying a user about natural disasters, evacuations, public health emergencies, safety warnings, or other emergency-related information. A message category may be a healthcare category. A healthcare message may include a message notifying the user about healthcare-related information. A healthcare message may include a message notifying the user about a healthcare appointment, a vaccine reminder, medical test results, public health alerts, or other healthcare-related information. Other message categories may include categories related to charitable, religious, educational, or political topics, or general conversation.

In some implementations, the time-of-day subsystem 210 may cache the payload of the first message and the message category associated with the first message. Caching the first message may include caching an embedding generated based on the first message. Similar messages may result is similar generated embeddings. The time-of-day subsystem 210 may receive a second message. The time-of-day subsystem 210 may determining that the payload of the second message is within a similarity threshold to the payload of the first message. For example, the first message payload and the second message payload may be within a threshold string distance from each other, or respective embeddings generated from the first message payload and the second message payload may be within a threshold distance from each other in an embedding space. If the time-of-day subsystem 210 determines that the payload of the second message is within the similarity threshold to the payload of the first message, the time-of-day subsystem 210 may associate the message category of the first message with the second message instead of providing the payload of the second message to the AI model 212. This may reduce the usage of the AI model 212 and reduce the computational resources used by the messaging system 122.

In one implementation, the time-of-day subsystem 210 may determine that the message category associated with the first message is subject to a time-of-day restriction. In response, the time-of-day subsystem 210 may determine whether sending the first message at a current time associated with the recipient communication endpoint identifier complies with the time-of-day restriction. Sending the first message may comply with the time-of-day restriction if the current time associated with the recipient communication endpoint identifier is within a predetermined time range.

In some implementations, determining the current time associated with the recipient communication endpoint identifier may include the time-of-day subsystem 210 determining the time zone associated with a portion of the recipient communication endpoint identifier. Where the recipient communication endpoint identifier is a phone number, the portion of the recipient communication endpoint identifier may include an area code of the phone number. The time-of-day subsystem 210 may look up the time zone associated with the portion of the recipient communication endpoint identifier and calculate or look up the current time for the time zone.

In one implementation determining the current time associated with the recipient communication endpoint identifier may include the time-of-day subsystem 210 determining a time zone associated with a stored adjusted location associated with the recipient communication endpoint identifier. In some cases, a communication endpoint user may relocate (permanently or temporarily) to a location outside of the time zone associated with the portion of the communication endpoint identifier (e.g., area code). The new location may be the adjusted location. The location record database of the location record storage 108 may store a location record that includes the recipient communication endpoint identifier and the adjusted location. The time-of-day subsystem 210 may look up a location record associated with the recipient communication endpoint identifier in the location record database, obtain the adjusted location from the location record, look up the time zone associated with the adjusted location, and calculate or look up the current time for the time zone.

In one embodiment, in order to update a location record, the communication services platform 120 may receive location update data from a customer API of the platform 120. A customer may use the application 116 to provide the location update data to the platform 120 via the customer API. The location update data may include data indicating the recipient communication endpoint identifier and a new location. The platform 120 may update the adjusted location of a location record stored in the location record database based on the location update data.

In one implementation, if the time-of-day subsystem 210 determines that sending the first message at the current time associated with the recipient communication endpoint complies with the time-of-day restriction, the time-of-day subsystem 210 may send a time-of-day response to the messages queue subsystem 202. The time-of-day response may indicate that sending the first message complies with the time-of-day restriction. In response, the messages queue subsystem 202 may cause the first message to be forwarded to the communication endpoint identified by the recipient communication endpoint identifier.

In some implementations, if the time-of-day subsystem 210 determines that sending the first message at the current time associated with the recipient communication endpoint identifier does not comply with the time-of-day restriction, the time-of-day subsystem 210 may send a time-of-day response to the messages queue subsystem 202 that indicates that sending the first message does not comply with the time-of-day restriction. In response, the messages queue subsystem 202 may schedule the first message to be transmitted to the communication endpoint identified by the recipient communication endpoint identifier at a time at which sending the first message would comply with the time-of-day restriction. In some implementations, the rescheduled time may include the next time that sending the first message complies with the time-of-day restriction. The rescheduled time may include a time when the number of messages in the messages queue of the messages queue subsystem 202 is below a threshold number of messages (which may indicate that the rescheduled time is not a peak messaging time). The messages queue subsystem 202 may reschedule all messages being rescheduled (including the first message) uniformly over a subsequent time range where sending the messages would comply with the time-of-day restriction. The rescheduled time may include a time during the next compliant time range selected at random by the messages queue subsystem 202. In some implementations, the customer that provided the first message request may indicate to the communication services platform 120 that the platform 120 is not to perform a consent check regarding the first message request. For example, the customer may configure the customer's account data on the platform to indicate to the platform 120 to not perform consent checks for the customer's message forwarding requests. In response, the platform 120 may not use the consent subsystem 204 to determine whether the communication endpoint identifier is associated with an opt-out for message forwarding requests provided by that customer. Similarly, in one implementation, the customer that provided the first message request may indicate to the platform 120 that the platform 120 is not to perform a time-of-day restriction check regarding the first message request. For example, the customer may configure the customer's account data on the platform to indicate to the platform 120 to not perform time-of-day restriction checks for the customer's message forwarding requests. In response, the platform 120 may not use the time-of-day subsystem 210 to determine whether a message category associated with the first message forwarding request is subject to a time-of-day restriction for message forwarding requests provided by that customer.

FIG. 3 depicts a flow diagram of an example method 300 for location, consent, and reassigned identifier management for a communication services platform 120, in accordance with some implementations of the disclosure. In some implementations, the method 300 can be performed by the communication services platform 120, and in particular, the messaging system 122 and its consent subsystem 204, reassigned identifier subsystem 206, and/or time-of-day subsystem 210.

The method 300 of FIG. 3 and/or each of the method's 300 individual functions, routines, subroutines, or operations can be performed by a processing device, having one or more processing units (CPU) and memory devices communicatively coupled to the CPU(s). In some implementations, the method 300 can be performed by a single processing thread or alternatively by two or more processing threads, each thread executing one or more individual functions, routines, subroutines, or operations of the method. The method 300, as described below, can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the operations of the method 300 can be modified. Thus, the illustrated implementations should be understood only as examples, and the illustrated operations can be performed in a different order, while some operations can be performed in parallel. Additionally, one or more operations can be omitted. In some implementations. Thus, not all illustrated operations are required in every implementation, and other process flows are possible. In some implementations, the same, different, fewer, or greater operations can be performed. It may be noted that elements of FIGS. 1-2 may be used herein to help describe FIG. 3.

At operation 302, processing logic receives, by a communication services platform 120, from a customer of the platform 120, a first messaging request to transmit a first message. The first messaging request may include a first communication endpoint identifier of a recipient of the first message. Receiving the first message request may include the messages queue subsystem 202 receiving the first message. The first communication endpoint identifier may include the recipient endpoint identifier discussed above in relation to FIG. 2.

At operation 304, processing logic determines whether the first communication endpoint identifier is associated with an opt-out indicator. The first communication endpoint identifier may not be associated with an opt-out indicator if the consent subsystem 204 fails to locate, in the consent record database of the consent record storage 107 of the communication services platform 120, an opt-out record associated with the first communication endpoint identifier. For example, as discussed above, the messages queue subsystem 202 may send the first communication endpoint identifier and a sender identifier to the consent subsystem 204, and the consent subsystem 204 may perform a look up of a consent record in the consent record database and determine if the first communication endpoint identifier is associated with a consent record stored in the consent record database.

In one implementation, if the consent subsystem 204 determines that the first communication endpoint identifier is associated with an opt-out indicator, at operation 312, processing logic may prevent transmission of the first message. The first communication endpoint identifier may be associated with an opt-out indicator if the consent subsystem 204 locates, in the consent record database, an opt-out record associated with the first communication endpoint identifier. The consent subsystem 204 may then send the messages queue subsystem 202 a consent response indicating that the communication endpoint associated with the first communication endpoint identifier is opted-out from receiving communications from the customer. The messages queue subsystem 202 may prevent the messaging system 122 from forwarding the first message and may send an error message to the customer indicating that the first message cannot be sent.

However, if the consent subsystem 204 determines that the first communication endpoint identifier is not associated with an opt-out indicator, at operation 306, processing logic determines whether a message category associated with the first message is subject to a time-of-day restriction. For example, as discussed above in relation to FIG. 2, the messages queue subsystem 202 may provide the payload of the first message to the time-of-day subsystem 210, which may provide the first message payload to the AI model 212. The AI model 212 may generate an output based on the payload of the first message. The output may specify the message category associated with the first message. The time-of-day subsystem 210 may receive the output from the AI model 212.

In some implementations, the time-of-day subsystem 210 may cache the payload of the first message and the message category associated with the first message. If the time-of-day subsystem 210 determines that the payload of a second message is within a similarity threshold to the payload of the first message, the time-of-day subsystem 210 may associate the message category of the first message with the second message.

In one implementation, responsive to the message category of the first message not being subject to a time-of-day restriction, the method 300 may continue to operation 310, where the messaging system 122 forwards the first message to a communication endpoint identified by the first communication endpoint identifier, as discussed below. However, if the message category associated with the first message is subject to a time-of-day restriction, at operation 308, processing logic determines whether the current time of day complies with the time-of-day restriction. Operation 308 may include the time-of-day subsystem 210 determining that a current time of day associated with the first communication endpoint identifier is within a predetermined time range. The time range may include a time range indicated by the acceptable use policy of the platform 120 or applicable laws or regulations (e.g., an applicable law may restrict the sending of marketing messages to times between 8 a.m. and 8 p.m.).

In one implementation, the current time of day associated with the first communication endpoint identifier is determined for a time zone associated with a portion the first communication endpoint identifier (e.g., where the first communication identifier is a phone number, the portion may be the area code of the phone number). In some embodiments, the current time of day is determined for a time zone associated with a stored adjusted location that is associated with the first communication endpoint identifier. In one example, the time-of-day subsystem 210 may retrieve the stored location from a location record stored in the location record storage 108, as discussed above in relation to FIG. 2.

In some implementations, if the time-of-day subsystem 210 determines that the current time of day does not comply with the time-of-day restriction, at operation 314, processing logic delays the transmission of the first message. For example, the messages queue subsystem 202 may schedule the first message to be transmitted to the recipient communication endpoint at a time that complies with the time-of-day restriction. As discussed above, the rescheduled time may include the next time that sending the first message complies with the time-of-day restriction, a time when the number of messages in the messages queue subsystem 202 is below a threshold number of messages, or a time during the next compliant time range selected at random.

However, if the time-of-day subsystem 210 determines that causing the first message to be transmitted to the communication endpoint complies with the time-of-day restriction, at operation 310, processing logic causes the first message to be transmitted to the communication endpoint.

In some implementations, the method 300 may not include block 304 (determining whether the first communication endpoint identifier is associated with an opt-out indicator) and block 312 (preventing transmission of the first message). Instead, block 302 (receiving the first message request) may proceed to block 306 (determining whether a topic associated with the first message is subject to a time-of-day restriction). In one implementation, the method 300 may not include block 306 and block 308 (determinizing whether causing the first message to be transmitted complies with a time-of-day restriction). Instead, block 304 may proceed to block 310 (causing the first message to transmitted to the communication endpoint) or block 312.

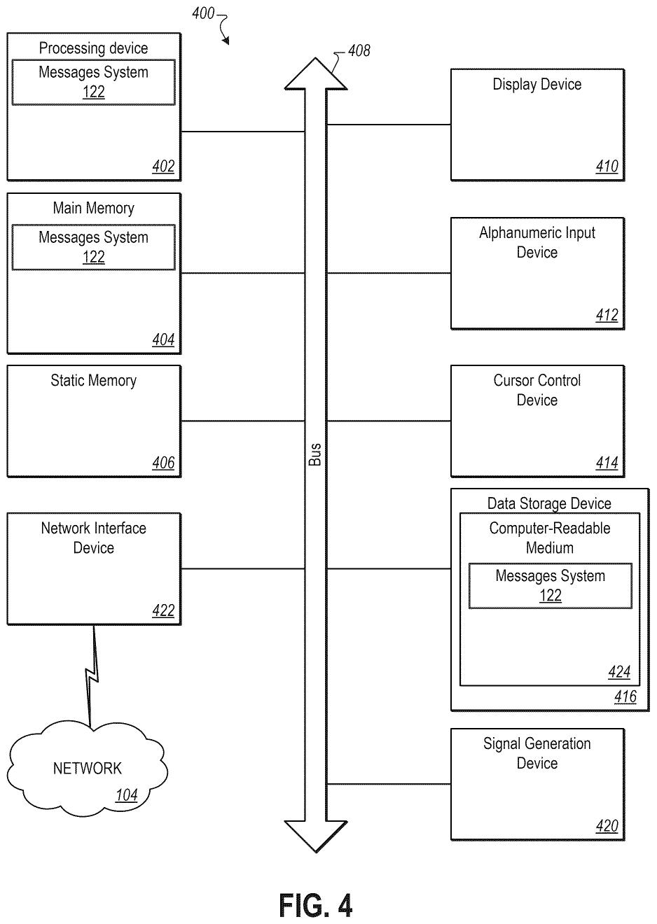

FIG. 4 is a block diagram illustrating an exemplary computer system 400, in accordance with an implementation of the disclosure. The computer system 400 executes one or more sets of instructions that cause the machine to perform any one or more of the methodologies discussed herein. Set of instructions, instructions, and the like may refer to instructions that, when executed by the computer system 400, cause the computer system 400 to perform one or more operations of the messaging system 122 and its consent subsystem 204, reassigned identifier subsystem 206, and/or time-of-day subsystem 210. The machine may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage device 416, which communicate with each other via a bus 408.

The processing device 402 represents one or more general-purpose processing devices such as a microprocessor, central processing unit, or the like. More particularly, the processing device 402 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 402 may also be one or more special-purpose processing devices such as an application specific integrated circuit (ASIC), a field programmable gate array (FPGA), a digital signal processor (DSP), network processor, or the like. The processing device 402 is configured to execute instructions of the system architecture 100, the messaging system 122 and its consent subsystem 204, reassigned identifier subsystem 206, and/or time-of-day subsystem 210 for performing the operations discussed herein.

The computer system 400 may further include a network interface device 422 that provides communication with other machines over the network 104, such as a local area network (LAN), an intranet, an extranet, or the Internet. The computer system 400 also may include a display device 410 (e.g., a liquid crystal display (LCD) or a cathode ray tube (CRT)), an alphanumeric input device 412 (e.g., a keyboard), a cursor control device 414 (e.g., a mouse), and a signal generation device 420 (e.g., a speaker).

The data storage device 416 may include a non-transitory computer-readable storage medium 424 on which is stored the sets of instructions of the system architecture 100, the messaging system 122 and its consent subsystem 204, reassigned identifier subsystem 206, and/or time-of-day subsystem 210 embodying any one or more of the methodologies or functions described herein. The sets of instructions of the system architecture 100, the messaging system 122 and its consent subsystem 204, reassigned identifier subsystem 206, and/or time-of-day subsystem 210 may also reside, completely or at least partially, within the main memory 404 and/or within the processing device 402 during execution thereof by the computer system 400, the main memory 404 and the processing device 402 also constituting computer-readable storage media. The sets of instructions may further be transmitted or received over the network 418 via the network interface device 422.

While the example of the computer-readable storage medium 424 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that causes the machine to perform any one or more of the methodologies of the disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “obtaining,” “determining,” “performing,” “suspending,” “disabling,” “providing,” “calculating,” “sending,” “receiving,” “notifying” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method, comprising:
receiving, by a communication services platform, from a customer of the communication services platform, a first messaging request to transmit a first message, wherein the first messaging request comprises a first communication endpoint identifier of a recipient of the first message;
determining whether the first communication endpoint identifier is associated with an opt-out indicator;
responsive to determining that the first communication endpoint identifier is not associated with an opt-out indicator, determining whether a message category associated with the first message is subject to a time-of-day restriction;
responsive to determining that the message category associated with the first message is subject to the time-of-day restriction, determining whether a current time of day complies with the time-of-day restriction; and
responsive to determining that the current time of day complies with the time-of-day restriction, causing the first message to be transmitted to the communication endpoint.

2. The method of claim 1, wherein determining that the first communication endpoint identifier is not associated with an opt-out indicator further comprises failing to locate, in a consent record storage of the communication services platform, an opt-out record associated with the first communication endpoint identifier.

3. The method of claim 2, further comprising:
obtaining, from a reassigned identifier service, a notification of the first communication endpoint identifier having been reassigned to a different user; and
generating the opt-out record comprising the first communication endpoint identifier.

4. The method of claim 2, further comprising:
obtaining, by the communication services platform, a consent record update request from the customer of the communication services platform, wherein the consent record update request comprises the first communication endpoint identifier; and
generating the opt-out record associated with the first communication endpoint identifier in the consent record storage.

5. The method of claim 2, further comprising:
obtaining, from a message routing provider, an opt-out notification associated with the first communication endpoint identifier; and
generating an opt-out record associated with the first communication endpoint identifier in the consent record storage.

6. The method of claim 1, further comprising:
obtaining, from a reassigned identifier service, data indicating that the first communication endpoint identifier has been reassigned to a different user;
locating, in a consent record storage of the communication services platform, the opt-out record associated with the first communication endpoint identifier; and
removing the opt-out record from the consent record storage.

7. The method of claim 1, wherein determining the message category associated with the first message comprises:
providing a payload of the first message to an artificial intelligence (AI) model; and
receiving, from the AI model, an output specifying the message category associated with the first message.

8. The method of claim 7, further comprising:
caching the payload of the first message and the message category associated with the first message; and
responsive to determining that the body of a second message is within a similarity threshold to the body of the first message, associating, with the second message, the message category of the first message.

9. The method of claim 1, wherein determining whether the current time of day complies with the time-of-day restriction comprises determining that a current time of day associated with the first communication endpoint identifier is within a time range indicated by at least one of an acceptable use policy of the communication services platform or applicable law or regulations.

10. The method of claim 1, wherein the current time of day is determined for a time zone associated with at least a portion the first communication endpoint identifier.

11. The method of claim 1, wherein the current time of day is determined for a time zone associated with a stored location associated with the first communication endpoint identifier.

12. The method of claim 1, further comprising: responsive to determining that causing the first message to be transmitted to the communication endpoint identified does not comply with the time-of-day restriction, scheduling the first message to be transmitted to the communication endpoint identified by the first communication endpoint identifier at a time that complies with the time-of-day restriction.

13. A system, comprising:
a memory; and
a processing device, coupled with the memory, configured to perform operations comprising:
receiving, by a communication services platform, from a customer of the communication services platform, a first messaging request to transmit a first message, wherein the first messaging request comprises a first communication endpoint identifier of a recipient of the first message,
determining whether the first communication endpoint identifier is associated with an opt-out indicator,
responsive to determining that the first communication endpoint identifier is not associated with an opt-out indicator, determining whether a message category associated with the first message is subject to a time-of-day restriction,
responsive to determining that the message category associated with the first message is subject to the time-of-day restriction, determining whether a current time of day complies with the time-of-day restriction, and
responsive to determining that the current time of day complies with the time-of-day restriction, causing the first message to be transmitted to the communication endpoint.

14. The system of claim 13, wherein determining that the first communication endpoint identifier is not associated with an opt-out indicator further comprises failing to locate, in a consent record storage of the communication services platform, an opt-out record associated with the first communication endpoint identifier.

15. The system of claim 13, wherein determining the message category associated with the first message comprises:
providing a payload of the first message to an artificial intelligence (AI) model; and
receiving, from the AI model, an output specifying the message category associated with the first message.

16. The system of claim 13, wherein determining whether the current time of day complies with the time-of-day restriction comprises determining that a current time associated with the first communication endpoint identifier is within a time range indicated by at least one of an acceptable use policy of the communication services platform or applicable law or regulations.

17. The system of claim 13, wherein the current time of day is determined for a time zone associated with a stored location associated with the first communication endpoint identifier.

18. A computer-readable storage medium comprising instructions that, when executed by a processing device, cause the processing device to perform operations comprising:
receiving, by a communication services platform, from a customer of the communication services platform, a first messaging request to transmit a first message, wherein the first messaging request comprises a first communication endpoint identifier of a recipient of the first message;
determining whether the first communication endpoint identifier is associated with an opt-out indicator;
responsive to determining that the first communication endpoint identifier is not associated with an opt-out indicator, determining whether a message category associated with the first message is subject to a time-of-day restriction;
responsive to determining that the message category associated with the first message is subject to the time-of-day restriction, determining whether a current time of day complies with the time-of-day restriction; and
responsive to determining that the current time of day complies with the time-of-day restriction, causing the first message to be transmitted to the communication endpoint.

19. The computer-readable storage medium of claim 18, wherein determining the topic associated with the first message comprises:
providing a payload of the first message to an artificial intelligence (AI) model; and
receiving, from the AI model, an output specifying the message category associated with the first message.

20. The computer-readable storage medium of claim 18, wherein the operations further comprise, responsive to determining that the current time of day does not comply with the time-of-day restriction, scheduling the first message to be transmitted to the communication endpoint identified by the first communication endpoint identifier at a time that complies with the time-of-day restriction.
